(19) United States
(12) Patent Application Publication
(10) Pub. No.: US 2015/0236527 A1
(43) Pub. Date: Aug. 20, 2015

(54) ASYMMETRIC DISPATCHING SYSTEMS, DEVICES, AND METHODS

(71) Applicant: MADA Energie LLC, New York, NY (US)

(72) Inventor: Arnold J. GOLDMAN, Jerusalem (IL)

(21) Appl. No.: 14/554,013

(22) Filed: Nov. 25, 2014

Related U.S. Application Data
(60) Provisional application No. 61/908,252, filed on Nov. 25, 2013.

(51) Int. Cl. H02J 7/00

(52) U.S. Cl. CPC H02J 7/007; H02J 7/0068

(57) ABSTRACT

An energy storage apparatus comprising a storage unit, a charge unit, and a discharge power units. The charge unit can have a power capacity that is N/efficiency higher than that of the discharge power unit, where N is significantly greater than unity. The apparatus can comprise a storage dissipation component that can selectively waste stored energy, incoming energy, or withdrawn energy such that the total energy storage capacity or rate capacity of energy storage is increased. Efficiency can be defined as maximum quantity of energy that can be withdrawn for a given quantity stored of the energy storage apparatus with zero waste energy storage selected. The charge unit can be connected to receive power from one or more power sources and the discharge power unit can be connected to dispatch power to a power consumer.

### CROSS-REFERENCE TO RELATED APPLICATIONS

The present application claims the benefit of U.S. Provisional Application No. 61/908,252, filed Nov. 25, 2013, which is hereby incorporated by reference herein in its entirety.

### FIELD AND BACKGROUND

Embodiments relate generally to the field of electrical energy and power, and more specifically to Time of Day (TOD) shifting, energy storage, energy and/or voltage regulation, and energy wasting (dumping).

Many energy storage facilities enable TOD shifting. Among other benefits, TOD shifting realizes a gain from the arbitrage in price between peak hours and off peak or super off peak hours. The difference in pricing at different periods throughout the day is attributed, among other things, to an imbalance in supply and demand. As more renewable energy enters the market and the electrical energy capacity generated from these sources increases, the imbalance between the supply and demand of electrical energy also increases.

In addition, there are existing issues with electrical energy generation such as the inability to switch off energy output from facilities such as coal and combined cycle power plants. The new and unreliable and/or unstable renewable energy entering the market is increasing the supply and demand imbalance. This raises concerns about over capacity in addition to the known issue of under capacity led by growing demand. Thus, both overcapacity and under capacity of electrical energy remain as yet unsolved.

### SUMMARY

In one or more embodiments, an energy storage apparatus includes at least one storage unit, at least one charge power unit, at least one discharge power unit. Each charge unit has a power capacity that is N/efficiency higher than that of each discharge power unit. N is greater than unity, for example, significantly greater than unity (e.g., at least one order of magnitude). Efficiency is defined as the maximum quantity of energy that can be withdrawn for a given quantity stored of the energy storage apparatus. The charge unit is connected to receive power from one or more power sources, and the discharge power unit is connected to dispatch power to a power consumer.

In one or more embodiments, an energy storage apparatus includes at least one storage unit, at least one charge unit, at least one discharge power unit, and a storage dissipation component. Each charge unit has a power capacity that is N/efficiency higher than that of each discharge power unit. N can be significantly greater than unity (e.g., at least an order of magnitude). Efficiency is defined as the maximum quantity of energy that can be withdrawn for a given quantity stored of the energy storage apparatus with zero waste energy storage selected. The storage dissipation component selectively wastes stored energy, incoming energy, or withdrawn energy such that the total energy storage capacity or rate capacity of energy storage is increased. The charge unit is connected to receive power from one or more power sources, and the discharge power unit is connected to dispatch power to a power consumer.

In one or more embodiments, an energy storage apparatus can have at least three modes of operation. A first mode of operation can be a charge stage, in which the apparatus consumes and stores energy. A second mode of operation can be a discharge stage in which the apparatus dispatches energy that has been stored therein. A third mode of operation can be an idle stage in which the apparatus neither consumers nor dispatches energy. The period of time to fully charge the apparatus is shorter than the period of time to fully deplete the apparatus, and the total power capacity of the charge stage divided by the efficiency of the apparatus is substantially greater than the total power capacity of the discharging stage of the apparatus.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements. As used herein, various embodiments can mean one, some, or all embodiments.

FIG. 1A illustrates an asymmetric Pumped Storage Hydro (PSH) facility during a charging cycle, in accordance with an embodiment.

FIG. 1B illustrates an asymmetric PSH facility during a discharging cycle, in accordance with an embodiment.

FIG. 2A illustrates an asymmetric Compressed Air Energy Storage (CAES) facility during a charging cycle, in accordance with an embodiment.

FIG. 2B illustrates an asymmetric CAES facility during a discharging cycle, in accordance with an embodiment.

FIG. 3A illustrates an asymmetric LAES facility during a charging cycle, in accordance with an embodiment.

FIG. 3B illustrates an asymmetric LAES facility during a discharging cycle, in accordance with an embodiment.

FIG. 4 illustrates an asymmetric LAES facility configured to selectively waste (i.e., dump) energy during a charging cycle, in accordance with an embodiment.

FIG. 5A illustrates an asymmetric electrical energy battery during a charging cycle, in accordance with an embodiment.

FIG. 5B illustrates an asymmetric electrical energy battery during a discharging cycle, in accordance with an embodiment.

FIG. 6 illustrates an energy storage apparatus, in accordance with an embodiment.

### DETAILED DESCRIPTION

In electrical energy markets, periods of over capacity on the grid can raise concerns. Over capacity of electrical energy can be met by Pumped Storage Hydroelectricity (PSH) facilities (or systems), which account for over 95% of energy storage in the United States. PSH may provide a viable solution for TOD shifting, obtaining the advantages of price arbitrage between different hours of the day. However, today's energy market may desire solutions that provide more than TOD shifting.

For example, the energy market may desire solutions that provide the possibility for asymmetrical electrical energy capacity to draw down electrical power from the electrical grid and/or electrical energy wasting (i.e., dumping).

The desire to asymmetrically draw down power and generate electrical energy may be a result of electrical energy regulation/stabilization desires. For example, the desire for electrical energy regulation may include a desire to draw down large amounts of electrical power during one period of time and a desire to generate a relatively smaller amount of electrical power during a second period of time. Thus, in one or more embodiments, components of an energy storage system may be constructed to provide a charging rate that is different than a discharge rate and be controlled to accept electrical energy from the grid that exceeds its storage capacity, e.g., by dumping the excess energy via a non-productive (i.e., non-electricity generating) process.

The desire for electrical energy wasting (i.e., dumping) may occur at times or locations where the electrical power that is desired to be drawn down from the electrical grid exceeds the draw down (or storage) capacity of an electrical energy storage facility. In such a case, there may be a desire to draw down electrical power from the electrical grid and to create additional storage capacity within the storage facility to further draw down electrical power from the grid. To create additional storage capacity, some of the energy stored by the storage facility can be discharged without generating undesired electrical energy during the discharge of the storage facility. Alternatively or additionally, the drawn down power from the electrical grid may be dumped without passing through the storage facility (i.e., by running a non-productive system).

Some embodiments include a PSH facility (or system) that may be charged and discharged. During a first period the PSH may draw down electrical energy (e.g., power) from the electrical grid and power a water pump or water pumps. This first period and process is referred to herein as the charging cycle, i.e., when electricity from the grid is used to store energy. The pump may pump water from a lower altitude water bank to a higher altitude water bank. During a second period of time, water from the higher altitude bank may flow down to the lower altitude bank. During the second period, the water may drive a water turbine and generate electrical energy. This second period and process is referred to herein as the discharging cycle, i.e., when stored energy is subsequently used.

In some embodiments, the PSH is an asymmetric PSH that is configured such that the electrical energy draw down capacity is larger (e.g., significantly larger, for example, at least an order of magnitude larger) than the electrical energy generation capacity. In other words, the charging capacity (e.g., rate of energy storage) may be greater than the discharge capacity (e.g., rate of stored energy use). This may be achieved by increasing the capacity of the charging cycle, for example, by assembling devices in such a way that will lead to an asymmetric charge-discharge facility. In one embodiment, the asymmetric PSH includes a first number of water pumps (e.g., two or more) that operate to pump water from a lower altitude bank to a higher altitude bank. During the discharge a second number of water turbines less than the first number of water pumps (e.g., when the number of water pumps is two, the number of water turbines may be one) is driven by the flow of water from the higher altitude water bank to the lower altitude water bank. This results in an asymmetric charge-discharge cycle in which the draw down capacity of electrical energy is larger than the electrical energy generation capacity. In some embodiments, the number and/or size/efficiency of water pump(s) exceed the number and/or size/efficiency of the water turbine(s) such that the draw down capacity of electrical energy of the asymmetric PSH is significantly larger (e.g., at least an order of magnitude larger) than the electrical energy generation capacity of the asymmetric PSH.

In some embodiments, the asymmetric PSH can waste (i.e., dump) electrical energy capacity such as, for example, excess electrical energy capacity. This may be achieved by flowing water down from the higher altitude bank to the lower altitude bank through a passage that bypasses the turbine. The bypass passage can have a valve that allows the water to flow down during periods in which high electrical energy capacity draw down is desired. The bypass passage may enable the PSH facility to draw down an excess amount of electrical energy capacity, by means of powering the pumps, and allowing the pumped water to flow back down through the bypass without generating electrical energy. Thus, excess electrical energy from the grid may be consumed by this non-productive process, i.e., by cycling water from the low altitude bank to the high altitude bank, and back down to the low altitude bank.

Some embodiments include a Compressed Air Energy Storage (CAES) facility (or system) that may be charged and discharged. During a first period, the CAES facility may draw down electrical energy from the electrical grid and power a compressor, or compressors (this period and process will be referred to as the charging cycle). The compressor may compress ambient air into a cavern. The compressed air may be stored in the cavern for usage at a later time when needed for electrical energy generation. During a second period of time, compressed air located in the cavern may be released through a turbine. During the release of the compressed air, the compressed air may drive the turbine to generate electrical energy (this period and process will be referred to as the discharging cycle).

In some embodiments, the CAES is an asymmetrical CAES that is configured such that draw down capacity is larger (e.g., significantly larger) than the electrical energy generation capacity. This may be achieved by increasing the capacity of the charging cycle, which may be done by assembling devices such as compressors and turbines in such a way that will lead to an asymmetric charge-discharge facility. In one embodiment, the asymmetrical CAES includes two (or more) compressors that operate to compress ambient air into a cavern, and the compressed air may be stored in the cavern. During the discharge only one turbine (or more, but no more than the amount of compressors) is driven by the flow of compressed air from the cavern to the environment, resulting in asymmetric charge-discharge cycles in which the CAES's draw down capacity of electrical energy is larger than the CAES's electrical energy generation capacity. In some embodiments, the number and/or size/efficiency of compressor(s) exceed than the number and/or size/efficiency of the turbine(s) such that the draw down capacity of electrical energy of the asymmetrical CAES is significantly larger than the electrical energy generation capacity.

In some embodiments, the asymmetric CAES can waste (dump) electrical energy capacity. This may be achieved by releasing the compressed air in the cavern to the environment through a passage bypassing the turbine. The passage may have a valve that may allow the passage of compressed air to be released down during periods in which high electrical energy capacity draw down is desired. The bypass passage may enable the CAES to draw down an excess amount of electrical energy capacity by means of powering the compressors and releasing to the environment the now compressed air through the pass way without generating electrical energy. Thus, electrical energy may be consumed (i.e., drawn down) and air may be cycled from the environment to the cavern (compressed) and back to the environment, without generating electrical energy.

Some embodiments include a Liquid Air Energy Storage (LAES) facility (or system) that may be charged and discharged. During a first period the LAES may draw down electrical energy from the electrical grid and power a compressor or compressors (this period and process will be referred to as the charging cycle). The compressor(s) of the LAES may compress ambient air. In some embodiments, the compressed air is further processed such that the compressed air may be transformed to liquid air that may be stored. Processing the air may involve devices such as compressor(s) that may compress the air. When the air is compressed the temperature of the air may increase. This increased temperature of the air may be extracted from the air and stored in a high temperature thermal energy storage unit. Thus, during the charging cycle both low temperature liquid air can be generated and stored and high temperature thermal energy can be generated and stored. During a second period, liquid air may be pumped through the thermal energy storage unit. The liquid air may exchange low temperature for high temperature from the storage unit. The liquid air may expand and be directed to drive a turbine, thus generating electrical energy (this period and process will be referred to as the discharging cycle).

In some embodiments, the LAES is an asymmetric LAES that is configured such that the electrical energy draw down capacity is larger (e.g., significantly larger) than the electrical energy generation capacity. This may be achieved by increasing the capacity of the charging cycle by, for example, assembling and/or configuring devices such as, for example, one or more compressor(s) and turbine(s) to provide an asymmetric charge-discharge facility. In some embodiments, the asymmetric LAES includes two (or more) compressors that operate to compress ambient air. In some embodiments, the asymmetric LAES includes one or more compressors, one or more of which is a sized up compressor in relation to the smaller turbine. The compressed air may be processed, liquefied and stored in the LAES alongside high temperature thermal energy that may be stored in the high temperature thermal energy storage unit. During the discharge cycle, the liquid air may be pumped through the high temperature thermal energy storage unit and through a smaller sized (e.g., smaller capacity) turbine, resulting in asymmetric charge-discharge cycles in which the draw down capacity of electrical energy is larger than the electrical energy generation capacity. In some embodiments, the compressor(s) and turbine(s) are sized such that the draw down capacity of electrical energy of the asymmetric LAES is significantly larger than the electrical energy generation capacity.

Some embodiments include an asymmetric apparatus such as, for example, a LAES, a CAES, and/or a PHS that can include two or more sets of compressor trains to achieve the compression process. Each train can have one or more compressors. The trains can be connected such that an incoming air stream can be directed through any of one, two, or more trains in parallel or in series. For example, in some embodiments, the asymmetric apparatus can include two trains where the first train has the power capacity of 10 MW and the second train has the power capacity of 20 MW. In such embodiments, the air compression stage can utilize only the first train with the power of 10 MW, only the second train with the power of 20 MW or both trains with the total power of 30 MW.

In some embodiments, the asymmetric charge and discharge processes (i.e., cycles) may result in an efficiency loss due to, for example, the charge/discharge pressures ratio. By changing the compression power (by adding or removing compressors from the compression stage), the pressure of the charge cycle may not be optimal in regard to the pressure of the expansion stage, or it may change the charge to discharge pressure ratio. In some embodiments, an asymmetric LAES comprises different conduits of the working fluid or air stream may have different sizing. In such embodiments, different sizing of conduits at various stages of the LAES may control the charge or discharge pressure in such a way that may result in a desirable charge to discharge ratio. By changing the conduits sizing a more optimal pressure may be achieved at the charge and/or discharge stages, which may decrease the efficiency loss related to the charge/discharge pressures ratio. In some embodiments, the changed conduits can be associated with the different compressors, or associated with one or more sections throughout the system, and/or two sets of conduits, or any other configuration which may result in the same desirable ratio. Changing the conduits can include, for example, changing the configurations, sizing, amount, etc. of the conduits differently as opposed to a similar storage system which may operate in a symmetrical mode of operation.

In some embodiments, the asymmetric charge and discharge processes may result in a less efficient heat exchange at one or more thermal storage units such as, for example, the high temperature thermal storage unit of a LAES. In some embodiments, due to the unequal mass flows of the charge and discharge processes, one of the streams may not exchange the maximum possible heat. In some embodiments, each of the thermal storage units of an asymmetric LAES comprises two or more storage tanks For indirect heat exchange with different charge and discharge mass flows, the thermal stores' heat transfer fluid can be pumped from one storage to the other at a different rate and/or the different air streams may be controlled to flow through the heat exchangers at different rates achieved by configuring the needed conduits and valves to allow such operations. In some embodiments, the asymmetric LAES includes a second set of conduits. For direct heat transfer with different charge and discharge mass flows, the air may be directed to one, two, or more of the thermal stores during one process/cycle and may be directed to a different combination of thermal stores during the other process/cycle. For example, in some embodiments, during the charging cycle which may constitute a larger flow mass into the different storage unit, the air stream direction enters the first storage tank, exits the first storage tank, and enters the second storage tank (and so on, as desired). In such embodiments, during the discharging cycle, the air stream would be directed to both (or more) storage tanks in parallel to meet a higher heat exchange efficiency. Valves can be placed on the conduits and/or storage tanks to allow control over the different air streams (i.e., the air stream of the charging cycle and/or discharging cycle). In some embodiments, configuration of the storage tanks may be configured from the charging cycle side and the valves can direct the charging cycle air stream through the two (or more) storage tanks in parallel. The discharging cycle air stream can be directed through one (or more, but not all) storage tanks during one period of the discharging cycle and through a different one (or more, but not all) storage tanks during a second period of the discharging cycle.

In some embodiments, an asymmetric LAES is configured to selectively waste (i.e., dump) electrical energy capacity. This can be achieved by the LAES by pumping the liquid air through the high temperature storage unit, extracting thermal energy from the storage unit, and releasing the now vaporized air back into the environment. Additionally or alternatively, liquid air can be used to cool down devices such as the compressor while it is operating. The liquid air can be passed through the LAES but not to drive a turbine, and not to generate electrical energy. Thus, electrical energy may be consumed (i.e., drawn down) and air may be cycled from the environment to the liquid storage tank and back to the environment, without generating electrical energy.

In some embodiments, an asymmetric LAES or CAES is configured to selectively waste (dump) electrical energy capacity. This can be achieved by directing the drawn down electricity to be used by heating elements that can be located at the apparatus's hot thermal storage. Such heating elements may then raise the temperature of the apparatus's hot thermal storage, which may increase the efficiency of the apparatus's discharge process while not charging or discharging the apparatus.

Some embodiments include an electrical storage (battery) facility (or apparatus, or system) that can be charged and discharged. During a first period the battery may draw down electrical energy from the electrical grid and store the electrical energy (this period and process will be referred to as the charging cycle). During a second period of time electrical energy stored in the battery may be conveyed back to the electrical grid (this period and process will be referred to as the discharging cycle).

In some embodiments, the electrical storage battery is an asymmetrical battery facility (or apparatus, or system) for which electrical energy draw down (i.e., charging/storage) capacity is larger (e.g., significantly larger) than the electrical energy generation capacity, and the asymmetry can be achieved by shifting the battery cells between a series configuration and a parallel configuration. For example, the electrical battery can be constructed from a plurality of electrical cells. During the charging cycle, the cells may be aligned in a parallel fashion, thus increasing the draw down capacity of the charging cycle. During the discharge mode, the cells will be aligned in a series fashion thus decreasing the capacity of the discharge.

In some embodiments, the asymmetrical drawn down and generation capacities of an asymmetrical battery can be achieved by increasing the capacity of the charging cycle. The capacity of the charging cycle can be increased by assembling an electrical energy storage unit (e.g., a battery) containing a plurality of smaller electrical cells, each containing a positive and a negative side (and each cell capable of being charged and discharged). During the charge cycle the cells may be configured to form a parallel circuit. The cell interconnections may be altered during the discharge cycle to be configured to form a series circuit. Thus, the charging cycle will draw down a larger capacity of electrical charge per unit time than the generation capacity during the discharge cycle.

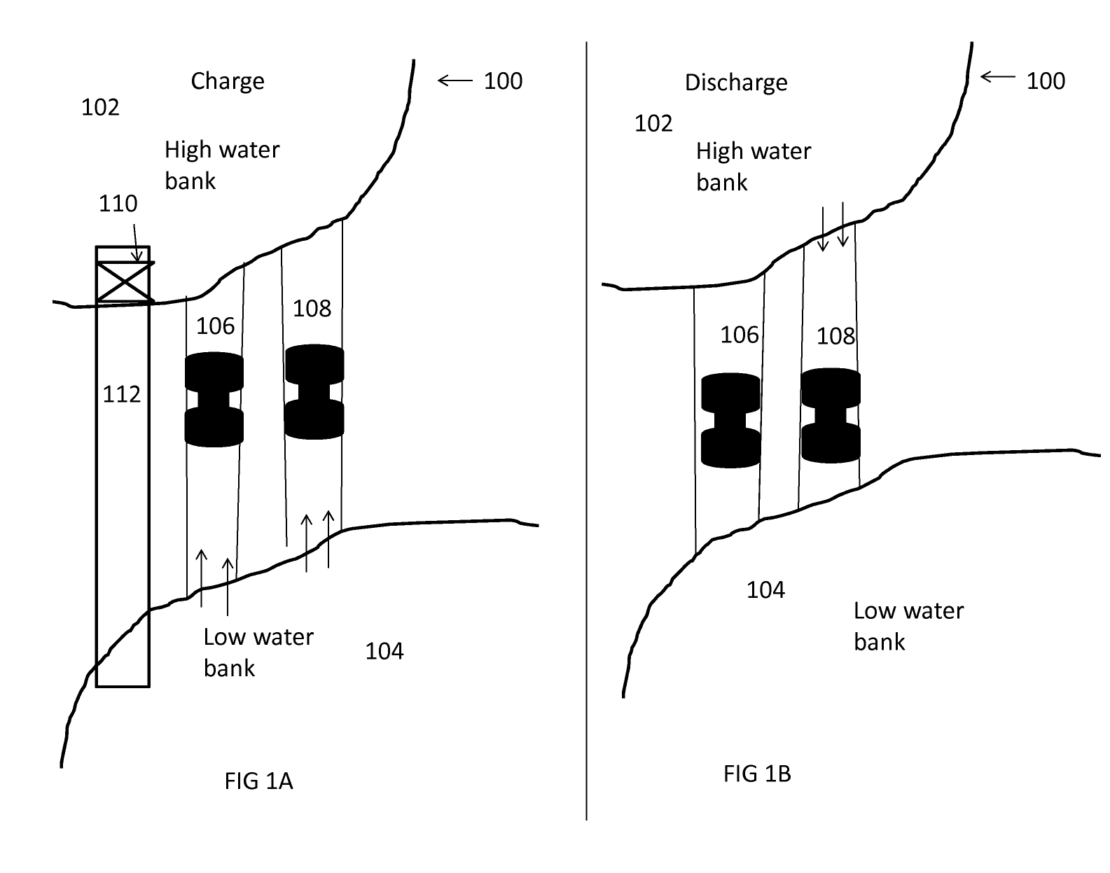

FIG. 1A illustrates an asymmetric Pumped Storage Hydro (PSH) facility (or apparatus, or system) 100 during a charging cycle, in accordance with an embodiment. PSH 100 includes a high altitude bank 102 of material (e.g., water or any other substance capable of storing potential energy by pumping or moving to a different height, such as, but not limited to, gravel), a low bank 104 of water (or other), and a plurality of water pumps, of which only two pumps 106, 108 are illustrated in the figure. During the charge cycle, PSH 100 may draw down electrical energy from the electrical grid (or any other electrical source) and power the pumps 106, 108. Water may be pumped upstream and stored in the high altitude bank 102 to be used during the discharge cycle.

FIG. 1B illustrates asymmetric PSH 100 during a discharging cycle, in accordance with an embodiment. Water from the high altitude bank 102 flows downstream through a pump/turbine 108 to drive the turbine and generate electrical energy. The flow of water is directed through a single turbine 108 and not through the rest of the turbines 106, thus resulting in an asymmetric charge-discharge cycle.

Asymmetric PSH 100 can be configured to selectively waste (i.e., dump) electrical energy during a period of time when there may be an excess of electrical energy on the electrical grid or any other electrical source. The PSH 100 may pump water from the low altitude bank 104 upstream to the high altitude bank 102. Due to the need to draw down a large capacity of electrical energy, water may flow down from the high altitude bank 102 to the low altitude bank 104, through a bypass channel 112. The bypass channel may contain a valve 110 for selectively allowing water to enter the bypass channel 112 during desired times and preventing water from entering the bypass channel 112 during periods of time when there is no desire to waste (i.e., dump) energy.

A controller (not shown) can be connected to valve 110 to control operation of the valve to selectively waste (i.e., dump) electrical energy based on, for example, a detection or prediction of a demand for energy uptake from a grid, energy supplier, or other power source. The same controller, or one or more additional controllers (not shown), can be connected to turbines 106, 108 to control the operation of PSH 100 as discussed above.

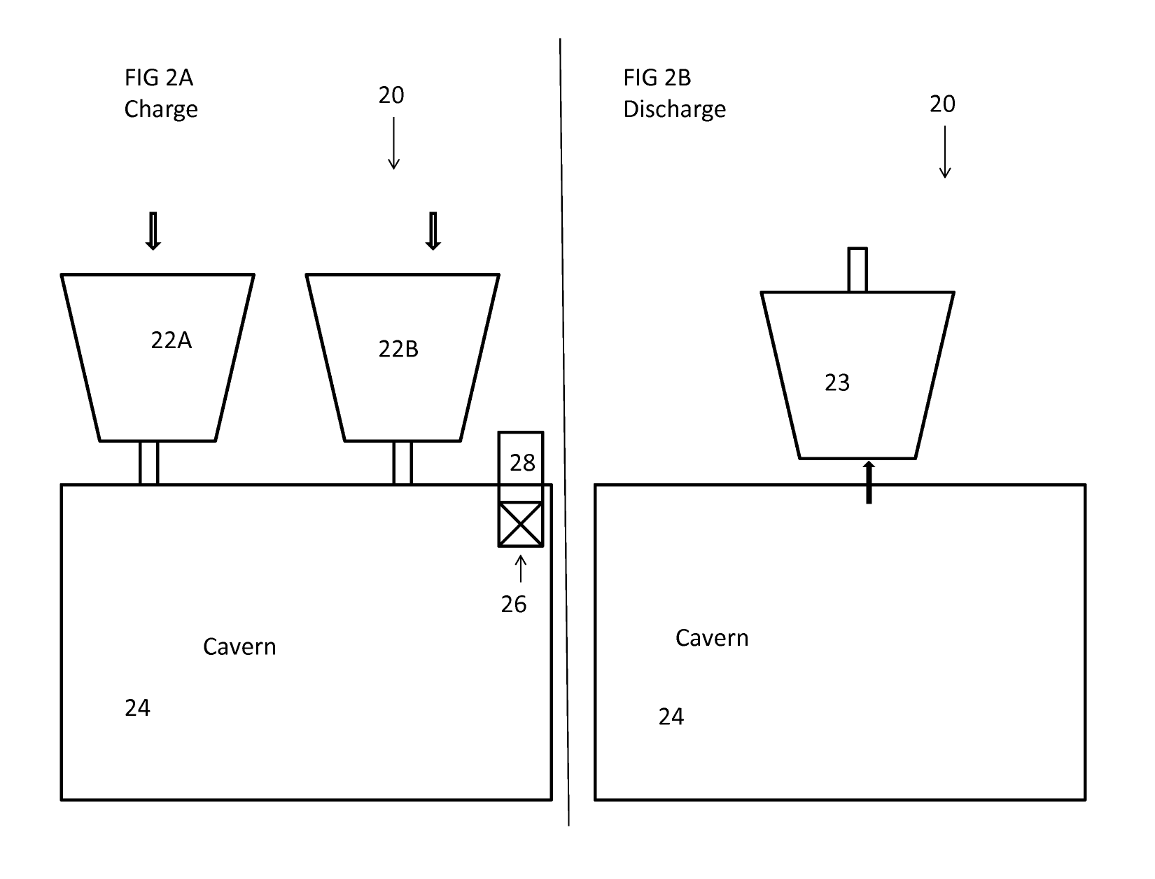

FIG. 2A illustrates an asymmetric Compressed Air Energy Storage (CAES) facility (or apparatus, or system) 20 during a charging cycle, in accordance with an embodiment. During the charge cycle, ambient air from the environment may be compressed by a plurality of compressors 22A, 22B and trapped into a cavern 24. In some embodiments, only one compressor is used, and the single compressor is configured to draw down more electrical energy capacity than the electrical energy generation capacity of the turbine 23. During the charging cycle, the CAES 20 may draw down electrical energy from the electrical grid (or any other electrical source) and power the compressors 22A, 22B. The compressors may compress air into the cavern 24. The air may be trapped and stored in the cavern 24 for later use.

FIG. 2B illustrates asymmetric CAES 20 during a discharging cycle, in accordance with an embodiment. Compressed air may be released from the cavern 24 and passed through a turbine 23 in order to generate electrical energy. The compressed air will drive a single turbine 23. In some embodiments, the compressed air drives more than a single turbine and the aggregated electrical energy generation capacity of the turbines is lower than the aggregated draw down electrical energy capacity of the compressors 22A, 22B, resulting in an asymmetric charge-discharge cycle.

Asymmetric CAES 20 can be configured to selectively waste (i.e., dump) electrical energy capacity. During times where there is a need for electrical energy waste, the CAES facility 20, may draw down electrical energy capacity and power one or more compressors 22A, 22B to compress air and trap the compressed air in cavern 24. Air that has been compressed into the cavern 24 may be released by a bypass channel 28 back to the environment. The bypass channel 28 may contain a valve 26, which can allow air to pass through the bypass channel during to waste/dump energy. Valve 26 can also prevent air from entering the bypass channel during periods where there is no desire to waste/dump energy.

A controller (not shown) can be connected to valve 26 to control operation of the valve to selectively waste (i.e., dump) electrical energy based on, for example, a detection or prediction of a demand for energy uptake from a grid, energy supplier, or other power source. The same controller or one or more additional controllers (not shown) can be connected to compressors 22A, 22B and/or cavern 24 and/or turbine to control the operation of CAES 20 as discussed above.

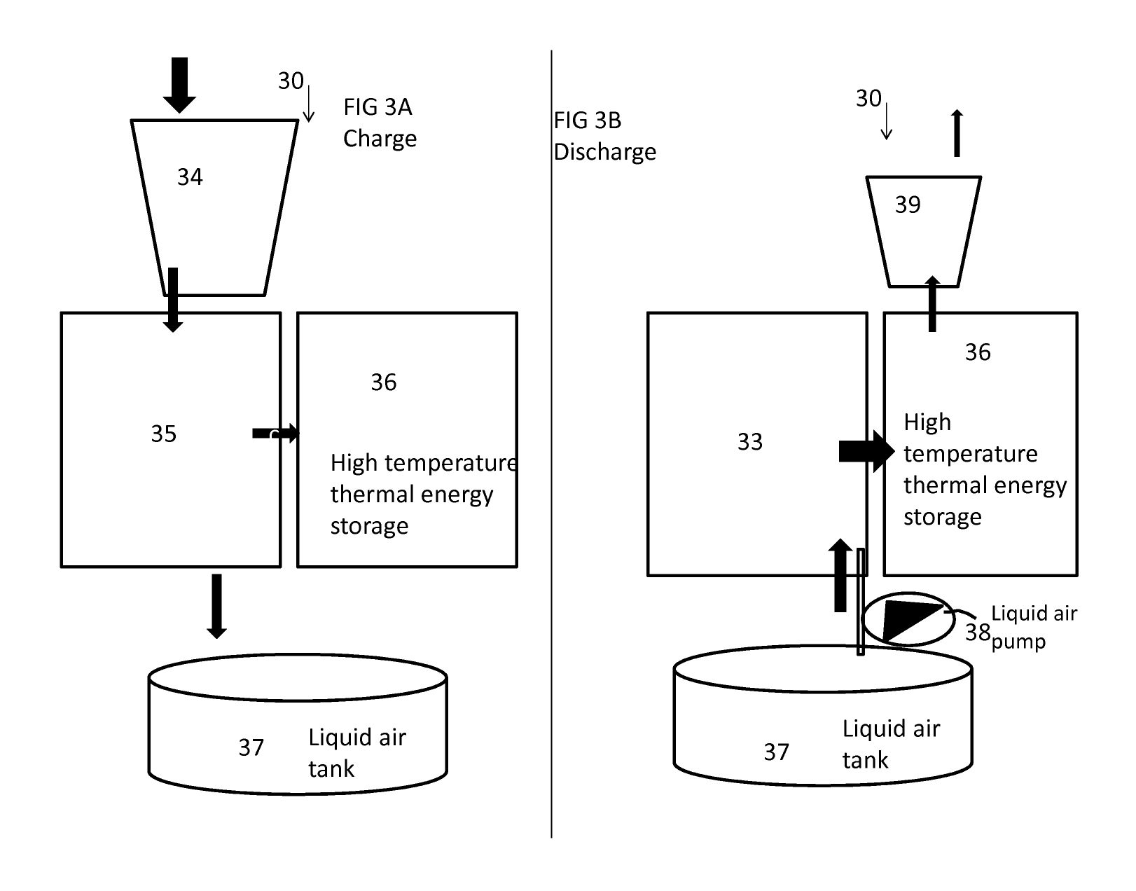

FIG. 3A illustrates an asymmetrical Liquid Air Energy Storage (LAES) facility (or apparatus, or system) 30 during a charging cycle, in accordance with an embodiment. During the charging cycle the LAES 30 may draw down electrical energy and operate a compressor 34. The compressor 34 can capture ambient air from the environment and compress the ambient air. The compressed air may be processed by compressed air processing device(s) 35 resulting in the transformation of the air from a gas form to a liquid form. Compressed air processing device(s) 35 can include different devices and apparatuses such as, for example, heat exchangers, air coolers, throttle devices, etc. The liquid air may be stored in a liquid air storage unit 37. During the process of liquid air generation, the temperature of the air may increase (e.g., at specific moments). The increased temperature of the air may be extracted from the air during the process by the compressed air processing device(s) 35. The extracted thermal energy may be stored in a high temperature thermal energy storage unit 36.

FIG. 3B illustrates the LAES 30 during a discharge cycle, in accordance with an embodiment. The liquid air stored in the liquid air storage unit 37 is pumped by a liquid air pump 38 through liquid air processing device(s) 33. Furthermore, the liquid air receives thermal energy from the high temperature thermal energy storage 36. The high thermal energy was stored in the high temperature thermal energy storage 36 during the charging cycle shown in FIG. 3A. The liquid air is vaporized and expanded and is directed to drive a turbine 39 to generate electrical energy. The capacity size of compressor 34 is larger than the capacity size of turbine 39 to provide an asymmetric LAES charge-discharge cycle.

In some embodiments, LAES 30 comprises a plurality of compressors and turbines. In such embodiments, the aggregated total of the draw down capacity of the compressors is larger than the aggregated total of the generation capacity of the turbines, thereby providing an asymmetric LAES charge-discharge cycle. LAES 30 can include one or more controllers (not shown) to control the operation of LAES 30 as discussed above.

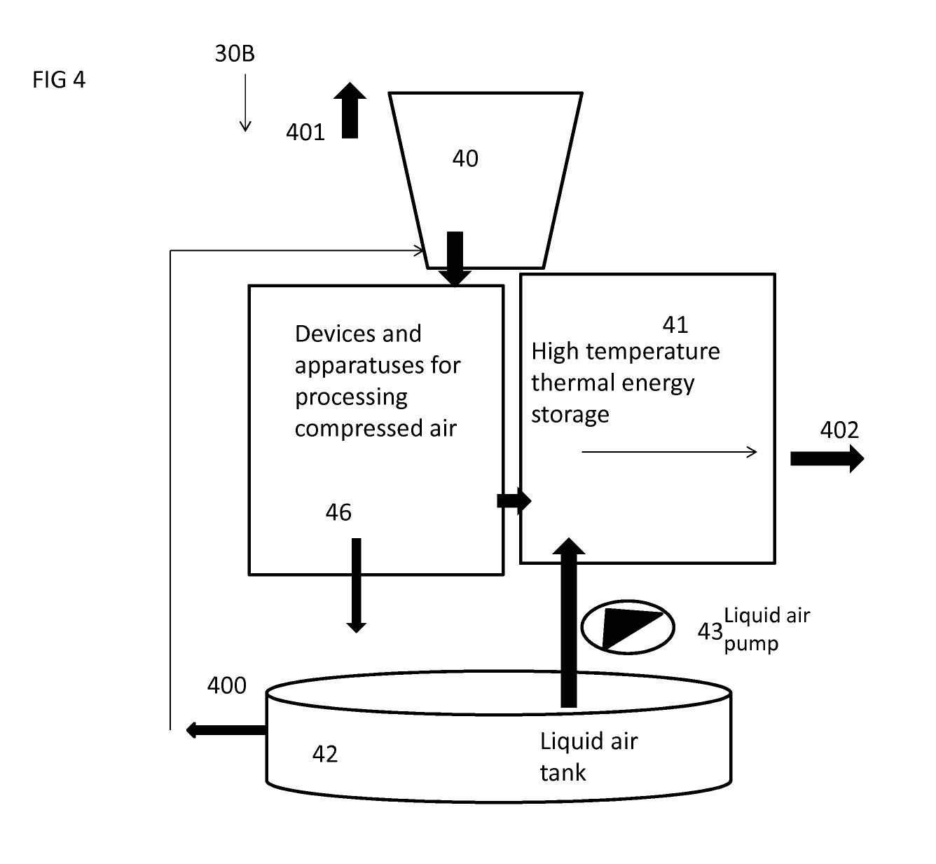

FIG. 4 illustrates an asymmetric Liquid Air Energy Storage (LAES) facility 30B configured to selectively waste (i.e., dump) energy during a charging cycle, in accordance with an embodiment. During times where there is a need for electrical energy waste, the LAES 30B can draw down electric energy capacity and operate one or more compressors 40. The compressed air may be processed by set of compressed air processing device(s) 46 and transform the air from a gas state to a liquid state. Liquid air may be stored in a liquid air storage unit 42. High temperature heat generated during the process of liquefaction may be extracted from the air and stored in a high temperature storage unit 41. Liquid air in the liquid air storage unit 42 may be pumped via a liquid air pump 43. The liquid air can extract high temperature heat from the high temperature storage unit 41, thereby enabling the system to continue to draw down electrical energy capacity. The liquid air that was cycled through the storage units can also be evaporated and released back to the environment, as shown by line 402. Additionally, the liquid air can be cycled and used to cool down the compressor 40, as shown by line 400. LAES facility 30B can selectively waste (i.e., dump) electrical energy capacity by performing one or more of: using the liquid air to extract high temperature heat from the high temperature storage unit 41, evaporating and releasing the liquid air back to the environment, and cycling the liquid air to cool down the compressor 40.

LAES 30B can include one or more controllers (not shown) to control operation of LAES 30B, as discussed above, including to control operation of the valve to selectively waste (i.e., dump) electrical energy based on, for example, a detection or prediction of a demand for energy uptake from a grid, energy supplier, or other power source.

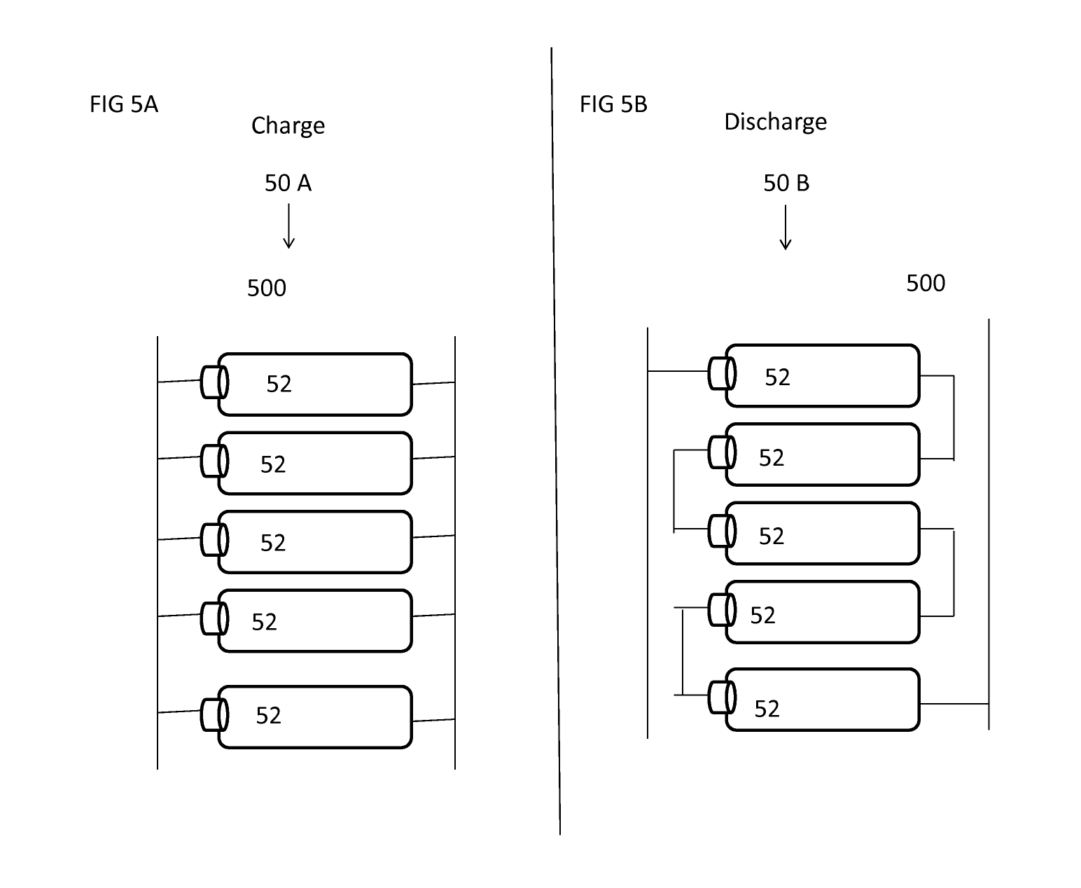

FIG. 5A illustrates an asymmetric electrical energy battery 50A during a charging cycle, in accordance with an embodiment. The battery 50A includes a plurality of electrical cells 52. During the charging cycle the cells are configured in a parallel circuit, thereby drawing down a larger capacity of electrical energy than a series circuit configuration.

FIG. 5B illustrates an asymmetric electrical energy battery 50B during a discharge cycle, in accordance with an embodiment. The electrical cells 52 are configured in a series circuit, thereby generating a smaller electrical energy capacity than a parallel circuit configuration. The electrical energy unit 500 may draw down larger electrical energy capacity than it generates.

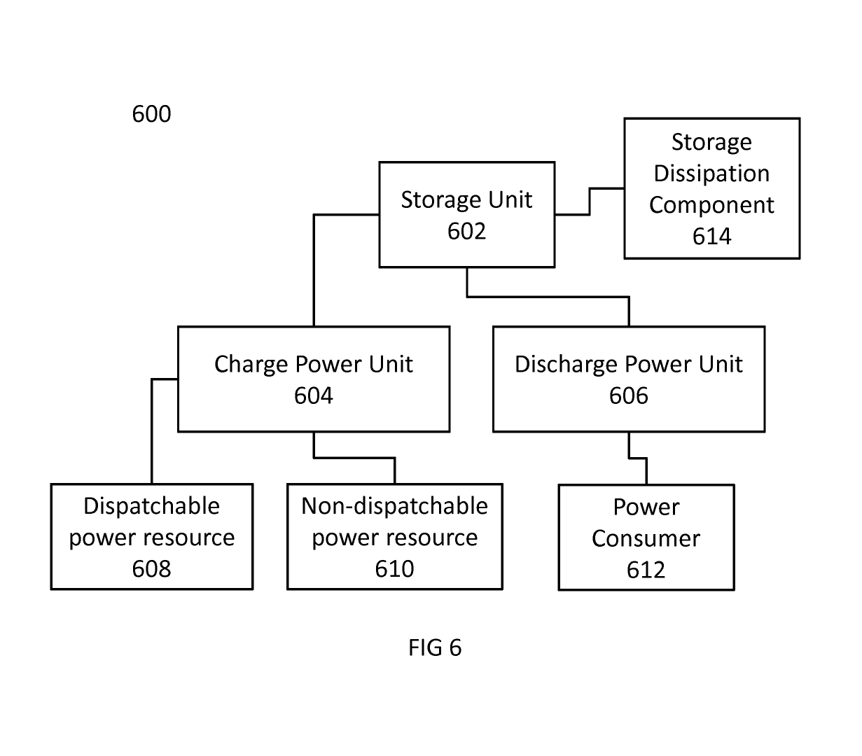

FIG. 6 illustrates an energy storage apparatus 600, in accordance with an embodiment. Energy storage apparatus 600 includes a storage unit 602, charge power unit 604, discharge power unit 606, dispatchable power resource 608, non-dispatchable power resource 610, power consumer 612, and storage dissipation component 614. The charge unit 604 can have a power capacity that is N/efficiency higher than that of the discharge power unit 606, where N is significantly greater than unity (e.g., N can be greater than 2, greater than 3, greater than 5, greater than 7). Storage dissipation component 614 can selectively waste stored energy, incoming energy, or withdraw energy such that the total energy storage capacity or rate capacity of energy storage is increased. Efficiency can be defined as the maximum quantity of energy that can be withdrawn for a given quantity stored of the energy storage apparatus 600 with zero waste energy storage selected. Storage dissipation component 614 can include a controller (not shown) for selectively wasting energy based on, for example, a detection or prediction of a demand for energy uptake from a grid, energy supplier, or other power source. For example, when it is predicted that the electrical grid has excess power that needs to be stored in the storage apparatus 600, the apparatus can control various components to non-productively discharge (i.e., dump) stored energy to make room for the to-be-stored energy. The rate of uptake (i.e., charging) may be significantly greater (e.g., at least ten times greater) as the rate of discharge. Any dumping may be performed at a rate similar to the charging and/or begin prior to or extend contemporaneously with at least some of the charging.

The charge unit 604 can be connected to receive power from one or more power sources such as, for example, a non-dispatchable power resource 610 and (optionally) a dispatchable power resource 608. For example, the dispatchable power resource can be an electricity power generation system that can vary to accommodate changes in load. For example, the dispatchable power resource can be a fossil fuel power plant. In contrast, the non-dispatchable power resource cannot accommodate changes in load because it is based on availability of a particular electricity generating resource. For example, the non-dispatchable power resource can be a solar power plant or wind power plant.

The discharge power unit is connected to dispatch power to a power consumer 612. In some embodiments, energy storage apparatus 600 includes a controller (not shown) for controlling the operation of energy storage apparatus 600 during charging and discharging cycles, as discussed hereinabove. In some embodiments, energy storage apparatus 600 can control the rate of energy waste based on the detection and/or prediction of a demand for energy uptake from a grid, energy supplier, or other power source.

In one or more embodiments of the disclosed subject matter, non-transitory computer-readable storage media and a computer processing systems can be provided. In one or more embodiments of the disclosed subject matter, non-transitory computer-readable storage media can be embodied with a sequence of programmed instructions for controlling asymmetric energy storage systems and discharging, charging, and/or dumping therein, the sequence of programmed instructions embodied on the computer-readable storage medium causing the computer processing systems to perform one or more of the disclosed methods.

It will be appreciated that the modules, processes, systems, and devices described above can be implemented in hardware, hardware programmed by software, software instruction stored on a non-transitory computer readable medium or a combination of the above. For example, a method for controlling asymmetric energy storage systems and discharging, charging, and/or dumping therein can be implemented, for example, using a processor configured to execute a sequence of programmed instructions stored on a non-transitory computer readable medium. For example, the processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and devices can be implemented as a single processor or as a distributed processor. Further, it should be appreciated that the steps mentioned herein may be performed on a single or distributed processor (single and/or multi-core). Also, the processes, modules, and sub-modules described in the various figures of and for embodiments herein may be distributed across multiple computers or systems or may be co-located in a single processor or system. Exemplary structural embodiment alternatives suitable for implementing the modules, sections, systems, means, or processes described herein are provided below.

The modules, processes, systems, and devices described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the methods, processes, modules, devices, systems, and computer program product can be implemented in hardware and/or software using any known or later developed systems or structures, devices and/or software by those of ordinary skill in the applicable art from the function description provided herein and with a general basic knowledge of electricity generation, electricity storage systems, and/or computer programming arts.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, systems, devices, and methods for asymmetric dispatching. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. An energy storage apparatus, comprising:
a storage unit;
a discharge power unit;
a charge unit having a power capacity that is N/efficiency higher than that of the discharge power unit, N being significantly greater than unity;
efficiency being defined as maximum quantity of energy that can be withdrawn for a given quantity stored of the energy storage apparatus;
the charge unit being connected to receive power from one or more power sources; and
the discharge power unit being connected to dispatch power to a power consumer.

2-3. (canceled)

4. The apparatus as in claim 1, wherein N is greater than 5.

5. (canceled)

6. The apparatus as in claim 1, wherein the one or more power sources comprise a non-dispatchable power resource and/or a dispatchable power resource.

7. An energy storage apparatus, comprising:
a storage unit;
a discharge power unit;
a charge unit having a power capacity that is N/efficiency higher than that of the discharge power unit, N being significantly greater than unity;
efficiency being defined as maximum quantity of energy that can be withdrawn for a given quantity stored of the energy storage apparatus with zero waste energy storage selected;
a storage dissipation component that selectively wastes stored energy, incoming energy, or withdrawn energy such that the total energy storage capacity or rate capacity of energy storage is increased;
the charge unit being connected to receive power from one or more power sources; and
the discharge power unit being connected to dispatch power to a power consumer.

8. (canceled)

9. The apparatus as in claim 7, wherein N is greater than 3.

10-11. (canceled)

12. The apparatus as in claim 7, wherein the one or more power sources comprise a non-dispatchable power resource and/or a dispatchable power resource.

13. The apparatus as in claim 7, wherein the storage dissipation component comprises a controller configured to control the rate of energy waste based on the detection of a demand for energy uptake from the one or more power sources, the one or more power sources comprising a grid or an energy supplier.

14. The apparatus as in claim 7, wherein the storage dissipation component comprises a controller configured to control the rate of energy waste based on the prediction of a demand for energy uptake from the one or more power sources, the one or more power sources comprising a grid or an energy supplier.

15. An energy storage apparatus comprising:
a controller to configure the energy storage apparatus to operate according to at least three modes of operation:
a charge stage in which the apparatus consumes and stores energy;
a discharge stage in which the apparatus dispatches energy which has been stored in the apparatus; and
an idle stage in which the apparatus neither consumes nor dispatches energy,
wherein a period of time to fully charge the apparatus is shorter than a period of time to fully deplete the apparatus, and
wherein a total power capacity of the charge stage divided by an efficiency of the apparatus is substantially greater than a total power capacity of the discharging stage of the apparatus.

16. The apparatus of claim 15, wherein the apparatus is a LAES apparatus, the apparatus further comprising:
a compression unit;
an expansion unit;
one or more high temperature thermal energy storage units;
a low temperature thermal energy storage; and
a liquid air storage tank,
wherein the compression unit operates during a period when the apparatus is configured to charge energy and the expansion unit operates during another period when the apparatus is configured to discharge energy.

17. The apparatus of claim 15, wherein the apparatus is a CAES apparatus, the apparatus further comprising:
a compression unit;
an expansion unit; and
a compressed air storage device and/or location,
wherein the compression unit operates during a period when the apparatus is configured to charge energy and the expansion unit operates during another period when the apparatus is configured to discharge energy.

18. The apparatus of claim 15, wherein the apparatus is a PHS apparatus, the apparatus further comprising:
a low altitude bank;
a high altitude bank;
a pump unit; and
a turbine unit,
wherein the pump unit operates during a period when the apparatus is configured to charge energy and the turbine unit operates during another period when the apparatus is configured to discharge energy.

19. The apparatus of claim 16, wherein the compression unit is comprised of at least one compressor, wherein all the compressors operate as a single compression unit and the power capacity of the compression unit is larger than the power capacity of the expansion unit.

20-23. (canceled)

24. The apparatus of claim 16, wherein the thermal energy storage units comprise one or more heat exchanges controlled to achieve a desired charge to discharge pressures ratio and a desired charge to discharge temperatures ratio.

25. The apparatus of claim 24, wherein the thermal energy storage units comprise a pump controlled to achieve a desired charge to discharge pressures ratio and a desired charge to discharge temperatures ratio by setting a desired flow rate of heat transfer fluid from the thermal energy storage units to the heat exchangers.

26-27. (canceled)

28. The apparatus of claim 25, wherein the thermal energy storage units further comprise conduits and valves configured to achieve a desired charge to discharge pressures ratio and a desired charge to discharge temperatures ratio by configuring flow of the working fluid to be in series or in parallel at all, some or any combination of the thermal energy storage units.

29. (canceled)

30. The apparatus of claim 16, further comprising heating elements that heat the high temperature thermal energy storage, wherein none, some or all of the incoming energy of the apparatus is directed to generate heat by the heating elements.

31. The apparatus of claim 17, wherein the compression unit is comprised of at least one compressor, wherein all the compressors operate as a single compression unit, and the power capacity of the compression unit is larger than the power capacity of the expansion unit.

32. (canceled)

33. The apparatus of claim 17, further comprising heating elements that heat a high temperature thermal energy storage, wherein none, some or all of the incoming energy of the apparatus is directed to generate heat by the heating elements.

34. The apparatus of claim 18, wherein the pump unit is comprised of at least one pump, wherein all the pumps operate as a single pump unit, and the power capacity of the pump unit is larger than the power capacity of the turbine unit.

35. (canceled)
